(19) United States
(12) Patent Application Publication
(10) Pub. No.: US 2007/0064960 A1
(43) Pub. Date: Mar. 22, 2007

(54) Apparatus to convert analog signal of array microphone into digital signal and computer system including the same

(75) Inventors: Young-hun An, Yongin-si (KR); Yang-sung Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/511,340

(22) Filed: Aug. 29, 2006

(30) Foreign Application Priority Data
Sep. 20, 2005 (KR) 2005-87393

(51) Int. Cl. H04R 3/00

(52) U.S. Cl. 381/92; 381/122

(57) ABSTRACT

An apparatus to convert analog signals of an array microphone into digital signals, and a computer system including the same including a first unit that receives and amplifies a plurality of analog signals of the array microphone, a second unit that converts the amplified analog signals into a plurality of corresponding PCM signals, and a third unit that converts PCM signals into a single signal.

### CROSS-REFERENCE TO RELATED APPLICATIONS

This application claims priority from Korean Patent Application No. 2005-87393 filed on Sep. 20, 2005, the disclosure of which is incorporated herein by reference.

### BACKGROUND OF THE INVENTION

1. Field of the Invention

Aspects of the present invention relate to an apparatus to convert analog signals of an array microphone into digital signals, and a computer system including the same, and more particularly, an apparatus to convert a plurality of analog signals of an array microphone and to produce a single digital signal in order to convert the analog signals into noise-resistant digital signals, and a computer system including the same.

2. Description of the Related Art

An array microphone comprises two or more microphones in order to increase the articulation index and sound quality under noisy conditions. In a conventional use of the array microphone in a computer system, such as a laptop computer, several microphones are arrayed and a cable connecting the microphones to an audio controller is lengthened to enable a certain distance between the microphones.

FIG. 1 illustrates a position of an array microphone in a conventional laptop computer, and an array configuration of an internal microphone.

In the conventional laptop computer 100, a first microphone 111 and a second microphone 112 are positioned with a specific location and distance between them. The first microphone 111 connects signals and two ground wires. The second microphone 112 also connects signals and two other ground wires. The four wires are connected and a signal wire is shielded in order to remove noise. Each signal is respectively connected to a microphone input of an audio controller, i.e., an MIC1 input and an MIC2 input, via the shielded wire.

FIG. 2 illustrates the configuration of a microphone signal input unit of a conventional audio controller.

Conventionally, a user's voice is converted into signals via a first microphone 111 and a second microphone 112, and the converted signals are transmitted to a MIC input 211 and a MIC2 input 212 of an audio controller 250 via each cable. The transmitted signals are amplified more than 20 dB (10 times) via mic preamps 221 and 222, and then converted into digital signals via an analog to digital (A/D) converter 230 to be suitable for signal processing. An algorithm for such functions as noise reduction, acoustic echo cancellation (AEC), and beam forming (BF) is applied to the digital signals, thus providing adequate sound quality for voice-applied software such as voice-over-Internet-protocol (VoIP), voice recognition, and voice instant messages (VIM).

The conventional art has problems in that as the distance between the first and second microphones and the audio controller is lengthened, noise is added to the microphone signal. Since the noisy signal is amplified and converted into a digital signal, the noise is transmitted to the controller. Also, the audio controller of the conventional computer system is susceptible to noise because it receives a microphone signal using an analog interface.

### SUMMARY OF THE INVENTION

Aspects of the present invention provide an apparatus to provide high-fidelity noise-free microphone signals by converting analog signals of an array microphone into digital signals, and a computer system including the same.

Another aspect of the present invention provides an apparatus to reduce the number of pins of an audio controller by converting analog signals of an array microphone into digital signals, and a computer system including the same.

Yet another aspect of the present invention provides an apparatus to lay out an array microphone in a desired position by providing noise-resistant signals, regardless of the length of a cable connecting a microphone and an audio controller, and a computer system including the same.

Additional aspects and/or advantages of the invention will be set forth in part in the description which follows and, in part, will be obvious from the description, or may be learned by practice of the invention.

According to an aspect of the present invention, there is provided an apparatus to convert analog signals of an array microphone into digital signals comprising a first unit that that receives and amplifies a plurality of analog signals of the array microphone, a second unit that converts the amplified analog signals into a plurality of corresponding pulse code modulation (PCM) signals, and a third unit that converts the PCM signals into a single signal comprising a plurality of channel signals.

According to another aspect of the present invention, there is provided a computer system comprising an array microphone comprising two or more microphones, an apparatus that converts analog signals of the array microphone into a single digital signal, and an audio controller that receives and processes the single digital signal and outputs it, wherein the apparatus converting analog signals of the array microphone into a single digital signal comprises a first unit that receives and amplifies a plurality of analog signals of the array microphone, a second unit that converts the amplified analog signals into a plurality of corresponding PCM signals, and a third unit that converts the plurality of corresponding PCM signals into a single signal comprising a plurality of channel signals.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a position of an array microphone in a conventional laptop computer and an array configuration of an internal microphone;

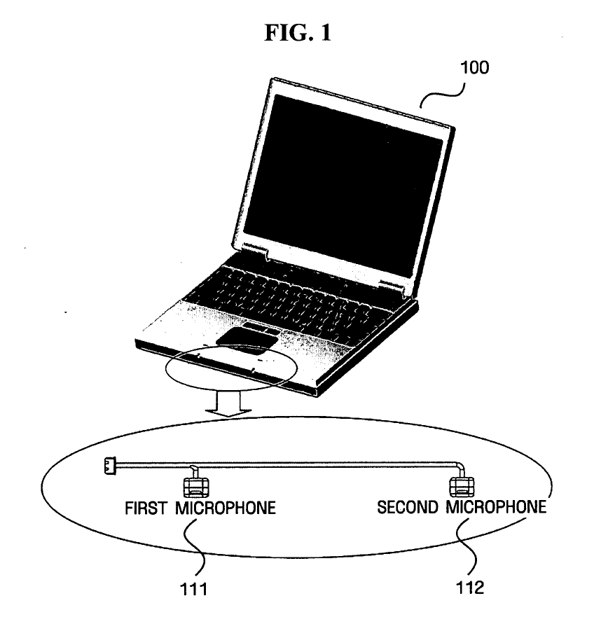

FIG. 2 illustrates the configuration of a microphone signal input unit of a conventional audio controller;

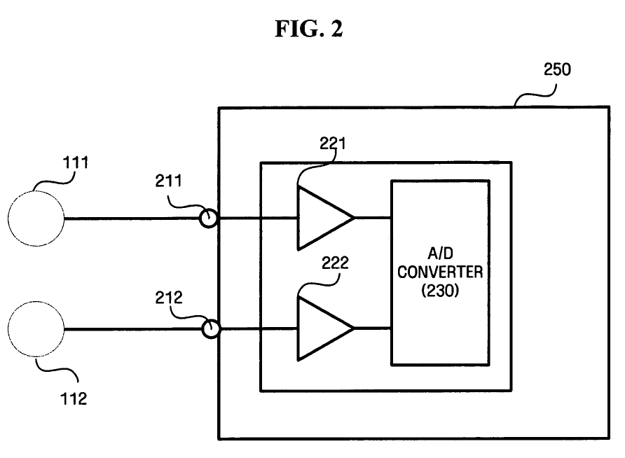

FIG. 3 is a block diagram illustrating a configuration of a computer system including an apparatus that converts analog signals into digital signals according to a first embodiment of the present invention;

FIG. 4 is a block diagram illustrating a configuration of a computer system including an apparatus that converts analog signals into digital signals according to a second embodiment of the present invention;

FIG. 5 illustrates converting a PCM signal into a Sony/Philips digital audio interface (S/PDIF) signal with biphase mark code (BMC) encoding.

FIG. 6 illustrates an S/PDIF signal format output by the device that converts analog signals to digital signals according to the first embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The present invention is described hereinafter with reference to flowchart illustrations of user interfaces, methods, and computer program products according to embodiments of the invention. Each block of the flowchart illustrations, and combinations of blocks in the flowchart illustrations, can be implemented by computer program instructions. These computer program instructions can be provided to a processor of a general purpose computer, special purpose computer, or other programmable data processing apparatus such that the instructions, which execute via the processor of the computer or other programmable data processing apparatus, create means to implement the functions specified in the flowchart block or blocks.

These computer program instructions may also be stored in a computer-usable or computer-readable memory that can direct a computer or other programmable data processing apparatus to function in a particular manner, such that the instructions stored in the computer-usable or computer-readable memory can create means to implement the functions specified in the flowchart block or blocks. The computer program instructions may also be loaded into a computer or other programmable data processing apparatus to cause a series of operational steps to be performed therein and produce a computer implemented process such that the instructions that execute on the computer or other programmable apparatus implement the functions specified in the flowchart block or blocks.

Each block of the flowchart illustrations may represent a module, segment, or portion of code, which includes one or more executable instructions to implement the specified logical function(s). It should also be noted that in some alternative implementations, the functions noted in the blocks may occur out of order. For example, two blocks shown in succession may in fact be executed substantially concurrently or in reverse order depending upon the functionality involved.

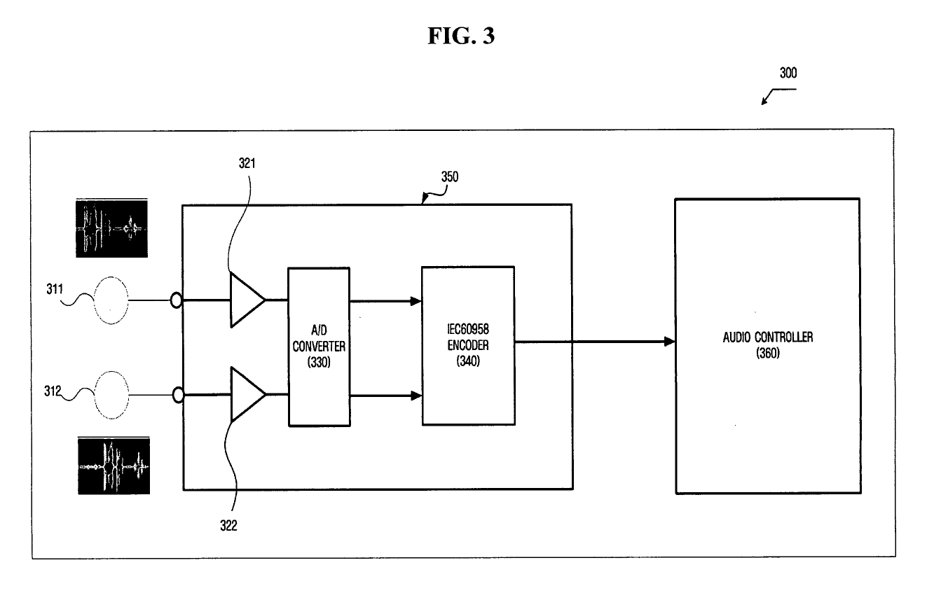

FIG. 3 is a block diagram illustrating a configuration of a computer system including an apparatus that converts analog signals into digital signals according to a first embodiment of the present invention.

A computer system 300 comprises a first microphone 311, a second microphone 312, and an apparatus 350 that converts analog signals of an array microphone into digital signals. The apparatus 350 comprises a first mic preamp 321, a second mic preamp 322, an A/D converter 330, an IEC60958 encoder 340, and an audio controller 360.

The array microphone uses two or more microphones in order to increase the articulation index and sound quality under noisy conditions. According to the present embodiment, the array microphone comprises the first microphone 311 and the second microphone 312. The first microphone 311 and the second microphone 312 convert acoustic energy into electrical energy. That is, the acoustic energy of a sound source is converted into a mechanical movement by a thin diaphragm, and an alternating voltage is created by the vibration of the diaphragm.

The first and second mic preamps 321 and 322 amplify weak signals so they can be processed in the digital conversion. When used in the computer system, the mic preamps amplify signals of the microphone by approximately 20 dB (ten times). The first mic preamp 321 amplifies analog signals of the first microphone, and transmits them to the A/D converter 330. The second mic preamp 322 amplifies analog signals of the second microphone, and transmits them to the A/D converter 330.

The A/D converter 330, used for many variations of digital signal processes, converts different analog signals into digital signals. The performance of the A/D converter 330 depends on resolution, i.e., the sensitivity to change in the size of the signals, and a sampling frequency, i.e., the time interval between signal sampling. An n-bit A/D converter converts the input analog signal into 2ⁿ signals.

The A/D converter 330 receives the analog signals amplified by the first and the second mic preamps 321 and 322, and outputs them as n-bit digital signals.

The IEC60958 encoder 340 receives the signal and converts the signal into a Sony/Philips digital audio interface (S/PDIF) signal. The S/PDIF is a standard audio transmission file format generally used in digital audio equipment, such as digital audio tape (DAT), or audio processing devices. The S/PDIF does not require an analog conversion, which results in signal degradation, in order for audio to be transmitted from a file to another. S/PDIF is standardized in IEC60958.

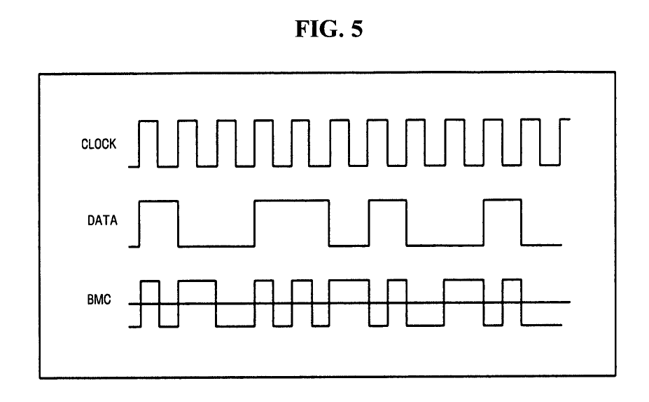

The IEC60958 encoder 340 encodes a signal received from the A/D converter 330, i.e., a pulse code modulation signal (hereinafter, referred to as PCM signal), into the biphase mark code (BMC) format, and then transmits the BMC-encoded signal in the S/PDIF signal format. In the computer system 300, the PCM signal of the first microphone 311 is BMC-encoded and transmitted via a first channel, while the PCM signal of the second microphone 312 is BMC-encoded and transmitted via a second channel. FIG. 5 illustrates converting the PCM signal into the S/PDIF signal by BMC-encoding.

The audio controller 360 receives, via a S/PDIF IN pin, the S/PDIF signal output from the IEC60958 encoder 340, applies an algorithm related to the microphone array technology, such as noise reduction, AEC, or BF, and provides adequate sound quality for voice software such as VoIP, voice recognition, or voice IM.

In sum, the user's voice is input to the first and second array microphones 311 and 312 and converted into analog signals, amplified by approximately 20 dB (ten times) via the first and second mic preamps 321 and 322, and then converted into PCM signals via the A/D converter 330.

The PCM signal is BMC-encoded via the IEC60958 encoder. The PCM signal of the first microphone 311, which is carried via the first channel, and the PCM signal of the second microphone 312, which is carried via the second channel, are converted into the S/PDIF signal and transmitted.

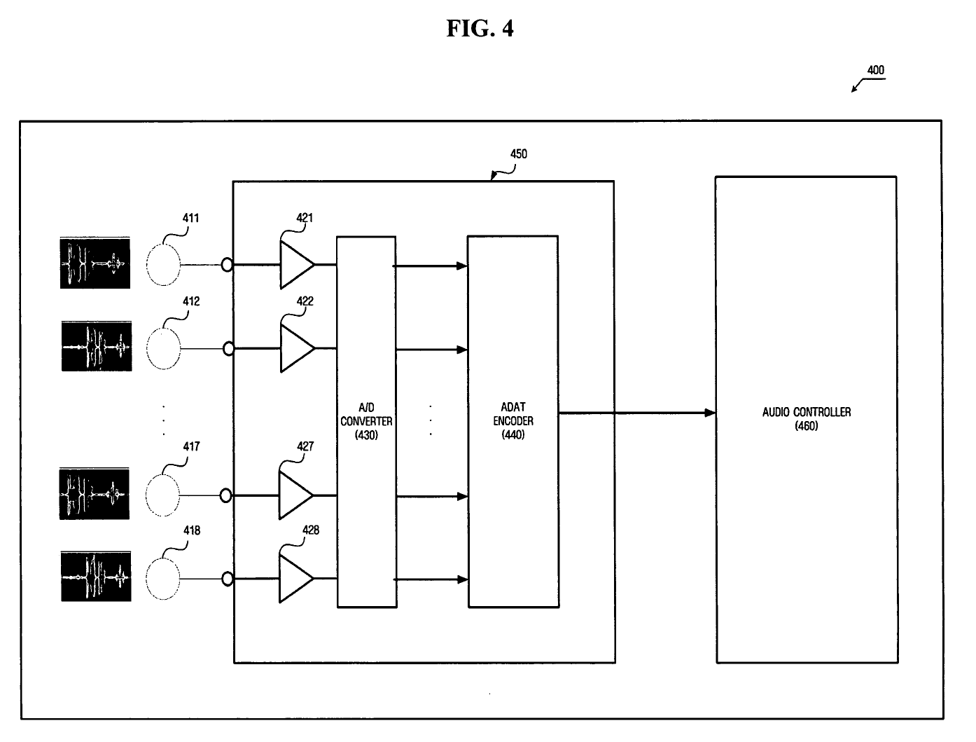

FIG. 4 is a block diagram illustrating a configuration of a computer system including an apparatus that converts analog signals into digital signals according to a second embodiment of the present invention.

A computer system 400 may have up to 8 array microphones (a first array microphone 411 through an eighth array microphone 418), and each signal of the array microphones is digitized by an apparatus 450 that converts analog signals of the array microphones into digital signals, and transmits them to an audio controller 460.

The apparatus 450 according to the second embodiment of the present invention comprises mic preamps 421 through 428 that amplify the analog signals of the array microphones, an AND converter 430 that receives the amplified signals from the mic preamps 421 through 428 and converts them into n-bit PCM signals, and an ADAT encoder 440 that receives the PCM signals from the eight channels and encodes them in a single data stream for transmissions according to ADAT optical protocol. (For more information see U.S. Pat. No. 5,297,181.) Since the ADAT encoder 440 supports input signals of up to eight channels, the computer system 400 may use up to eight microphones.

The audio controller 460 receives a single data stream from the ADAT encoder 440, processes it, and provides an audio signal to other components of the computer system 400.

Each component illustrated in FIG. 3 or FIG. 4, corresponds to, but is not limited to, a software or hardware component which performs certain tasks, such as a Field Programmable Gate Array (FPGA) or an Application Specific Integrated Circuit (ASIC). A component may advantageously be configured to reside in an addressable storage medium and configured to execute on one or more processors. The functionality provided for in the components may be combined into fewer components and/or further separated into additional components.

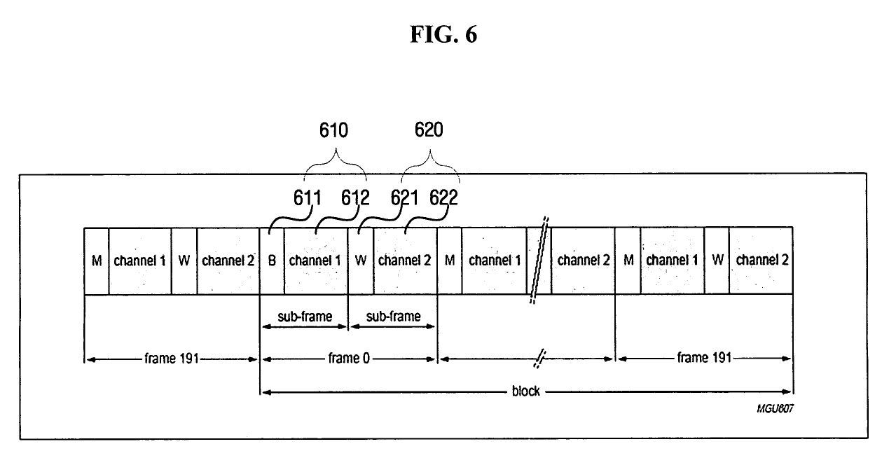

FIG. 6 illustrates an S/PDIF format signal output by the device that converts analog signals to digital signals according to the first embodiment of the present invention.

The two channel PCM signals may be transmitted to various series of blocks. Each block has 192 frames in order. Each frame consists of two sub-frames 610 and 620, and each sub-frame includes single channel data 612 or 622. Since the sequences of preambles 611 and 621 do not appear in valid channels of the S/PDIF stream, the preambles can be easily inserted into the S/PDIF stream.

The sub-frame includes an audio sample that can have a width of up to 24 bits, a valid bit that indicates whether the sample is valid, 1 bit of user data, and a 1-bit channel status. Data bits of each frame are modulated using BMC techniques. The letters “M”, “W”, and “B” of the signal formats in FIG. 6 symbolize the preambles.

As described above, according to an apparatus to convert analog signals of an array microphone into digital signals and a computer system including the same, the following effects can be anticipated.

First, noise can be prevented when signals of an array microphone are transmitted to an audio controller.

Second, problems, in that a cable must be lengthened and the number of pins must be increased in an array structure to embody the array microphone, are solved using a single signal wire, and the cost of cable units can be reduced.

Third, the array microphone can be set in a desired position.

Fourth, the audio controller receives and processes digital signals of S/PDIF IN instead of an analog input of MIC1 and MIC2, thereby producing high fidelity microphone signals.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to convert analog signals of an array microphone into digital signals, the apparatus comprising:
a first unit that receives and amplifies a plurality of analog signals from the array microphone;
a second unit that converts the amplified plurality of analog signals into a plurality of corresponding digital signals; and
a third unit that converts the plurality of corresponding digital signals into a single data stream comprising a plurality of channel signals.

2. The apparatus as claimed in claim 1, wherein:
the third unit is an IEC60958 encoder that encodes the plurality of corresponding digital signals into biphase mark code (BMC) format, and outputs the plurality of encoded signals in the Sony/Philips digital audio interface (S/PDIF) format comprising two channel signals; and
the plurality of analog signals are received from two microphones of the array microphone.

3. The apparatus as claimed in claim 1, wherein the third unit is an ADAT encoder.

4. The apparatus as claimed in claim 3, wherein the ADAT encoder receives up to eight channel signals.

5. The apparatus as claimed in claim 1, wherein the plurality of corresponding digital signals are pulse code modulation (PCM) signals.

6. The apparatus as claimed in claim 1, wherein the first unit, the second unit, and the third unit are implemented from instructions of a program code executed by a programmable data processing apparatus.

7. The apparatus as claimed in claim 6, wherein the programmable data processing apparatus is a computer system.

8. The apparatus as claimed in claim 1, wherein the first unit is one or more mic preamps to receive and amplify the plurality of analog signals from the array microphone.

9. The apparatus as claimed in claim 1, wherein the first unit is a plurality of mic preamps to receive and amplify the plurality of analog signals, and each one of the plurality of mic preamps corresponds to one of the plurality of analog signals.

10. The apparatus as claimed in claim 1, wherein the first unit amplifies the plurality of analog signals by 20 dB.

11. A programmable data processing apparatus comprising:
an array microphone comprising two or more microphones;
an apparatus to convert analog signals of the two or more microphones into a single data stream; and
an audio controller to receive, process, and output the single data stream;
wherein the apparatus to convert analog signals of the two or more microphones into the single data stream comprises:
a first unit that receives and amplifies a plurality of analog signals from the array microphone;
a second unit that converts the amplified plurality of analog signals into a plurality of corresponding digital signals; and
a third unit that converts the plurality of corresponding digital signals into the single data stream comprising a plurality of channel signals.

12. The apparatus as claimed in claim 11, wherein:
the third unit is an IEC60958 encoder that encodes the plurality of corresponding digital signals into the biphase mark code (BMC) format, and outputs the plurality of encoded signals in the S/PDIF format comprising two channel signals; and
the plurality of analog signals are received from two of the microphones.

13. The apparatus as claimed in claim 11, wherein the third unit is an ADAT encoder.

14. The apparatus as claimed in claim 13, wherein the ADAT encoder receives up to eight channel signals.

15. The apparatus as claimed in claim 11, wherein the plurality of digital signals are pulse code modulation (PCM) signals.

16. The apparatus as claimed in claim 11, wherein the first unit, the second unit, and the third unit are implemented from instructions of a program code executed by the apparatus.

17. The apparatus as claimed in claim 11, wherein the programmable data processing apparatus is a computer system.

18. The apparatus as claimed in claim 11, wherein the first unit is one or more mic preamps to receive and amplify the plurality of analog signals from the array microphone.

19. The apparatus as claimed in claim 11, wherein the first unit is a plurality of mic preamps to receive and amplify the plurality of analog signals, and each one of the plurality of microphone preamps corresponds to one of the plurality of analog signals.

20. The apparatus as claimed in claim 11, wherein the first unit amplifies the plurality of analog signals by 20 dB.

21. An apparatus to convert analog signals of an array microphone into digital signals, the apparatus comprising:
a first unit that receives a plurality of analog signals from the array microphone and converting the plurality of analog signals into a plurality of corresponding digital signals; and
a second unit that converts the plurality of corresponding digital signals into a single data stream comprising a plurality of channel signals.

22. The apparatus as claimed in claim 21, wherein:
the second unit is an IEC60958 encoder that encodes the plurality of corresponding digital signals into biphase mark code (BMC) format, and outputs the plurality of encoded signals in the Sony/Philips digital audio interface (S/PDIF) format comprising two channel signals; and
the plurality of analog signals are received from a first microphone and a second microphone.

23. The apparatus as claimed in claim 21, wherein the second unit is an ADAT encoder.

24. The apparatus as claimed in claim 23, wherein the ADAT encoder receives up to eight channel signals.

25. The apparatus as claimed in claim 21, wherein the plurality of corresponding digital signals are pulse code modulation (PCM) signals.

26. The apparatus as claimed in claim 21, wherein the first unit and the second unit are implemented from instructions of a program code executed by a programmable data processing apparatus.

27. The apparatus as claimed in claim 26, wherein the programmable data processing apparatus is a computer system.

28. The apparatus as claimed in claim 21, further comprising an other unit that receives and amplifies the plurality of analog signals from the array microphone prior to converting the plurality of analogy signals into the plurality of corresponding digital signals.

29. The apparatus as claimed in claim 28, wherein the other unit is one or more mic preamps to receive and amplify the plurality of analog signals from the array microphone.

30. The apparatus as claimed in claim 28, wherein the other unit is a plurality of mic preamps to receive and amplify the plurality of analog signals, and each one of the plurality of mic preamps corresponds to one of the plurality of analog signals.

31. The apparatus as claimed in claim 28, wherein the other unit amplifies the plurality of analog signals by 20 dB.

32. A method of converting analog signals of an array microphone into digital signals, the method comprising:
receiving a plurality of analog signals from the array microphone;
converting the plurality of analog signals into a plurality of corresponding digital signals; and
converting the plurality of corresponding digital signals into a single data stream comprising a plurality of channel signals.

33. The method as claimed in claim 32, wherein:
the plurality of corresponding digital signals are IEC60958-converted into the single data stream;
the plurality of digital signals are IEC60958-encoded into biphase mark code (BMC) format, and outputs the plurality of encoded signals in the Sony/Philips digital audio interface (S/PDIF) format comprising two channel signals; and
the plurality of analog signals are output from two microphones of the array microphone.

34. The method as claimed in claim 32, wherein the plurality of corresponding digital signals are ADAT-encoded into the single data stream.

35. The method as claimed in claim 34, wherein the ADAT encoder receives up to eight channel signals.

36. The method as claimed in claim 32, wherein the plurality of corresponding digital signals are pulse code modulation (PCM) signals.

37. The method as claimed in claim 32, further comprising amplifying the plurality of analog signals from the array microphone before converting the plurality of analog signals into the plurality of corresponding digital signals.

38. A computer readable medium encoded with the method of claim 32 implemented by a computer.
